(19) United States
(12) Patent Application Publication
(10) Pub. No.: US 2013/0278589 A1
(43) Pub. Date: Oct. 24, 2013

(54) DISPLAY CONTROL SYSTEM

(71) Applicant: Hung-Ta Liu, (US)

(72) Inventors: Hung-Ta Liu, Hsinchu County (TW); Ching-Cheng Lee, Hsinchu County (TW)

(73) Assignee: Hung-Ta Liu, Hsinchu County (TW)

(21) Appl. No.: 13/854,929

(22) Filed: Apr. 1, 2013

(30) Foreign Application Priority Data
Apr. 20, 2012 (TW) 101114201

(51) Int. Cl. G09G 5/22

(52) U.S. Cl. CPC G09G 5/22
USPC 345/213

(57) ABSTRACT

A display control system includes a display unit, a timing control unit. The display unit includes at least one source driving unit and a gate driving unit. The source driving unit includes an output buffer unit, a plurality of switches and a register unit. The output buffer unit is used to output image signals or high impedance signals. The switches are used to receive the image signals or high impedance signals. The gate driving unit is used to output gate driving signals. The timing control unit is used for controlling the timing of the source driving unit and the gate driving unit.

### BACKGROUND OF THE INVENTION

1. Field of the Invention

The present invention relates to a display control system, especially a display control system capable of reducing the power consumption of a display according to the features of image signals displayed by the display.

2. Description of the Prior Art

Due to their slim shapes, low power dissipation and low radiation, liquid crystal displays (LCDs) are widely applied in mobile electronic devices such as notebooks, monitors, and PDAs (personal digital assistants). Besides, the cost of manufacturing LCDs is lower than the cost of manufacturing CRT displays, thus gradually, thus LCD products are more and more popular.

Because display products are necessary electronic devices in daily life, the power consumptions accumulated by each and every family are considerable large. At present, many countries in the world are keen on reducing consumptions of power and carbons. Thus, a display having the power saving function is needed. With prior art technologies of LCDs or CRT displays, a display can not greatly reduce power consumptions according to the types of images to be displayed on the panel. Although some prior art displays are configured to a comprise a built-in timing shutdown system, so that even if the user left the display turned on without manually turning off the display, the display can automatically be shut down when the counting of the built-in timing shutdown system is over. However, the aforementioned method can only reduce power consumptions when the user is not using the display, and can not reduce power consumptions when the display is used. Thus, prior displays can not to reduce power consumptions when the displays are used. Further, prior displays cannot to reduce power consumptions when only a partial of images on the screen of the display are required to be viewed.

### SUMMARY OF THE INVENTION

An embodiment of the present invention relates to a display control system, which comprises a display unit and a timing control unit. The display unit comprises at least one source driving unit and a gate driving unit. The at least one source driving unit comprises an output buffer unit, a plurality of switches and a register unit. The output buffer unit is used for outputting image signals or high impedance signals. The plurality of switches are coupled to the output buffer unit. Each switch of the plurality of switches comprises an input end coupled to the output buffer unit, for receiving the image signals transmitted from the output buffer unit, and an output end coupled to at least one data line for outputting the image signals or high impedance signals transmitted from the output buffer unit to the input end to the at least one data line. The register unit is coupled to the control end of the switch for controlling the switch to output image signals or high impedance signals to the at least one data line, or for outputting an open circuit signal to the at least one data line. The gate driving unit is coupled to the plurality of gate lines, for outputting gate driving signals to the plurality of gate lines. The timing control unit is coupled to the output buffer unit and the gate driving unit, for outputting image signals to the output buffer unit and controlling timings of the at least one source driving unit and the gate driving unit.

Another embodiment of the present invention relates to an electronic device, which comprises a plurality of source driving units and a timing control unit. Each source driving unit of the plurality of source driving units has a position orientating serial number or a sequential number. The timing control unit is coupled to the plurality of source driving units for controlling the plurality of source driving units according to sequential numbers of the plurality of source driving units.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a display control system according a first embodiment of the present invention.

FIG. 2 shows the source driving unit of the display control system of the present invention.

FIGS. 3A and 3B show an enabling unit of the gate driving unit of the present invention generating enabling signals.

FIG. 4 shows a display control system according a second embodiment of the present invention.

FIG. 5 shows a display control system according a third embodiment of the present invention.

FIG. 6 shows a display control system according a fourth embodiment of the present invention.

FIG. 7 shows an electronic device according a fifth embodiment of the present invention.

### DETAILED DESCRIPTION

Some phrases are referred to specific elements in the present specification and claims, please notice that the manufacturer might use different terms to refer to the same elements. However, the definition between elements is based on their functions instead of their names. Further, in the present specification and claims, the term “comprising” is open type and should not be viewed as the term “consisted of.” Besides, the term “electrically coupled” can be referred to either directly connecting or indirectly connecting between elements.

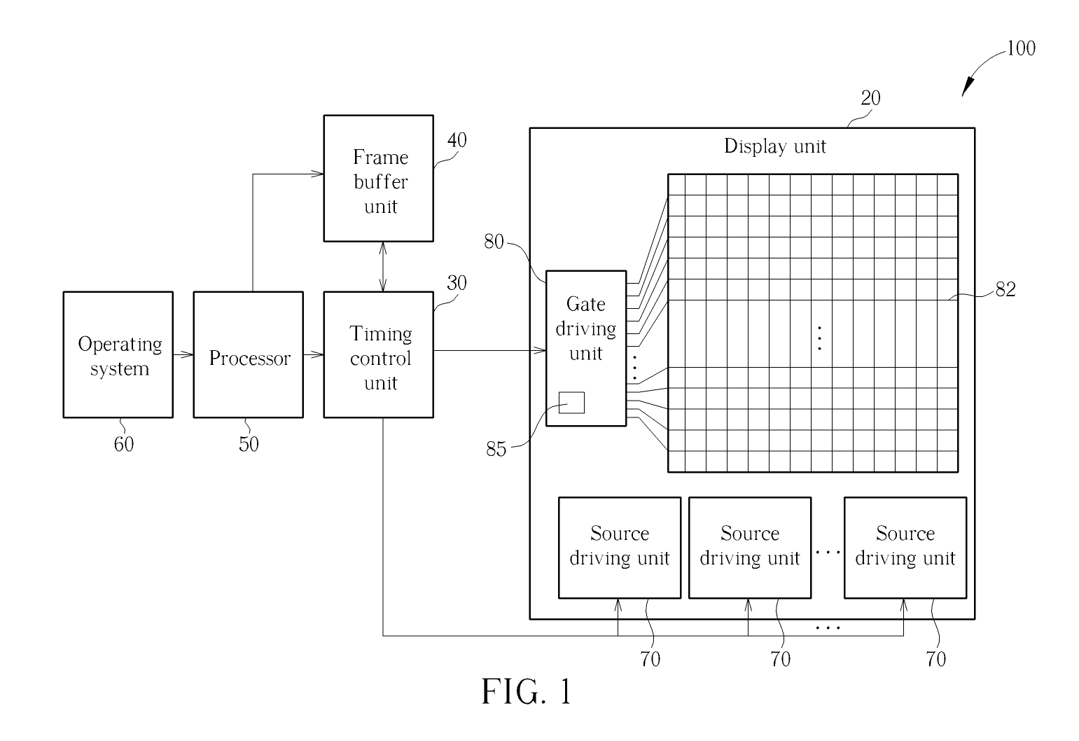

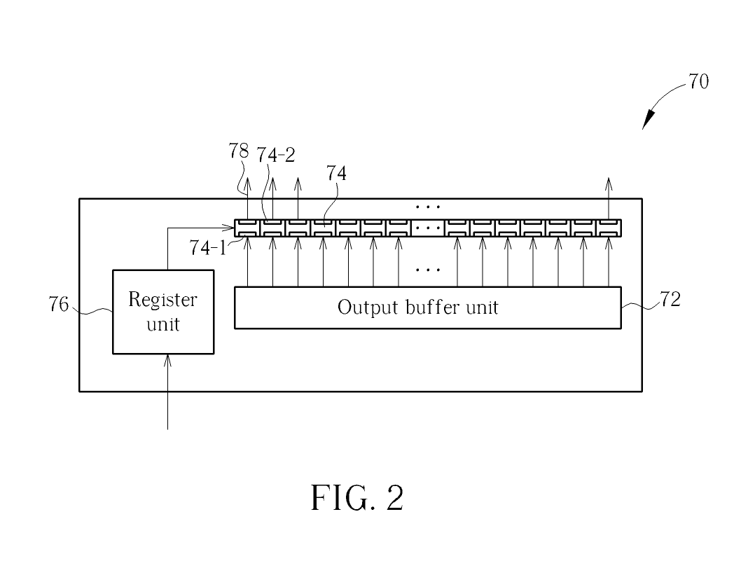

The embodiments and figures are provided as follows in order to illustrate the present invention in detail, but please notice that the claimed scope of the present invention is not limited by the provided embodiments and figures. Please refer to FIGS. 1 and 2, which shows a display control system 100 according a first embodiment of the present invention. As shown in FIG. 1, the display control system 100 comprises a display unit 20, a timing control unit 30, a processor 50 and an operating system 60. The display unit 20 comprises a plurality of source driving units 70 and a gate driving unit 80.

FIG. 2 shows the source driving unit 70 of the display control system 100 of the present invention. As shown in FIG. 2, each source driving unit of the plurality of source driving units 70 comprises an output buffer unit 72, a plurality of switches 74 and a register unit 76. The output buffer unit 72 is used for outputting image signals or high impedance signals. The image signal can be signals for generating a static image, a dynamic image, or an image having a portion of static image and a portion of dynamic image. Each source driving unit of the plurality of source driving units 70 can be configured to comprise a position orientating serial number or a sequential number. With this configuration, the display control system 100 can respectively control each source driving unit of the plurality of source driving units 70 quickly and effectively.

The plurality of switches 74 are coupled to the output buffer unit 72. Each switch of the plurality of switches 74 comprises an input end 74_1 coupled to the output buffer unit 72 for receiving the image signals transmitted from the output buffer unit 72, and an output end 74_2 coupled to a data line 78 for outputting the image signals or high impedance signals transmitted from the output buffer unit 72 to the input end 74_1 to a data line 78. The present invention does not limit the number of the data lines 78. That is, in the source driving unit 70 in FIG. 2, each switch 74 can be coupled to one data line 78 or a plurality of data lines 78. Besides, the plurality of data lines 78 can be divided into a plurality sets of data lines, and the source driving unit 70 can separately control the plurality of data lines 78 to output image signals or high impedance signals. The register unit 76 is coupled to the control end of the switch 74 for controlling the switch 74 to output image signals or high impedance signals to the at least one data line 78, or for outputting an open circuit signal to the at least one data line 78.

The high impedance signal can refer to a signal capable of substantially turning off the switch 74, such as a floating signal or an open circuit signal. However, the present invention does not limit the high impedance signal to a specific type of signal. Besides, all of the switches 74 can output image signals according to the signals transmitted from the register unit 76 to the switches 74 through using the register unit 76 to control the switches 74. Further, the source driving unit 70 can be configured to that only one switch of the switches 74 output the high impedance signal and the other switches of the switches 74 output image signals, or multiple switches of the switches 74 output the high impedance signals and the other switches of the switches 74 output image signals.

The gate driving unit 80 is coupled to the plurality of gate lines 82, for outputting gate driving signals to the plurality of gate lines 82. The gate driving unit 80 can be configured to comprise at least an enabling unit 85. The enabling unit 85 is used to disable a set of gate lines 82 when the image corresponding to the set of gate lines 82 is a static image. The static image can be an image presented in text or in figure, e.g. a JPEG file. The static image can also be a remaining image, a slow image or a wallpaper of a personal computer. The static image can be partially static or fully static. Further, the gate lines 82 can be divided into a plurality sets of gate lines, and the gate driving unit 80 can be used to respectively control the timing of each set of the plurality of sets of gate lines 82 to output image signals or high impedance signals, and to respectively control the enabling and disabling of each set of the plurality of sets of gate lines 82.

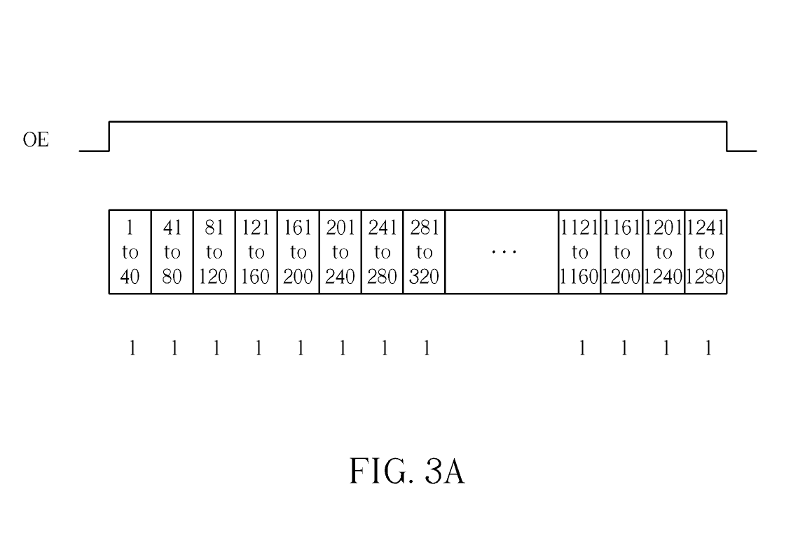

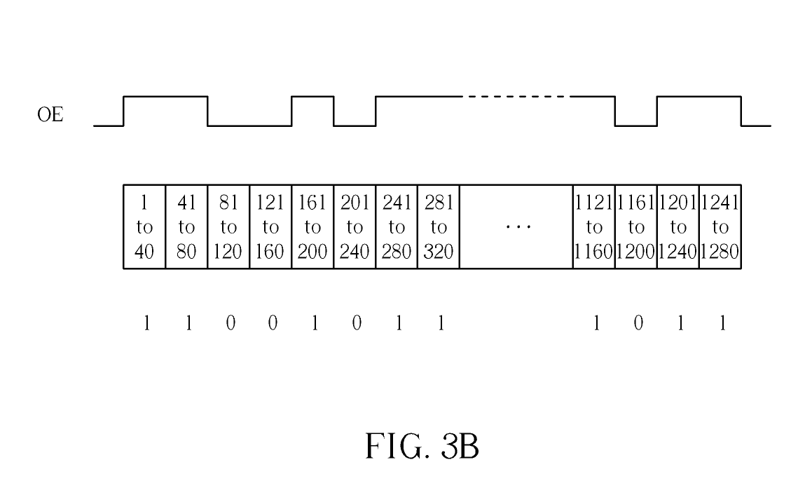

Please refer to FIGS. 3A and 3B, which show an enabling unit 85 of the gate driving unit 80 of the present invention generating enabling signals. In FIGS. 3A and 3B, the enabling signal OE corresponds to a plurality sets of gate lines. Each set of the plurality of sets of gate lines has 40 gate lines. When the display unit 20 is displaying an image that is fully dynamic, the enabling signal OE enables all the gate lines as shown in FIG. 3A. However, when the display unit 20 is displaying an image that is partially static, the enabling signal OE will not enables all the gate lines, but disable gate lines corresponding to the partially static images, to reduce the power consumption of the display. For example, in FIG. 3B, because the gate lines 81 to 120, 161 to 200 correspond to the static images, the enabling signal OE disables the gate lines 81 to 120, 161 to 200. The gate driving unit 80 of the present invention can be also configured to not comprise the enabling unit 85. The power consumption of the display can be reduced through merely controlling the source driving unit 70 to output high impedance signals.

The timing control unit 30 is coupled to the output buffer unit 72 and the gate driving unit 80, for outputting image signals to the output buffer unit 72 and controlling timings of the source driving units 70 and the gate driving unit 80. Further, the timing control unit 30 can be configured to couple to the register unit 76 and at least an enabling unit 85, to control the register unit 76 and the enabling unit 85. The frame buffer unit 40 is coupled to the timing control unit 30 for temporarily storing image signals of static images and outputting the temporarily stored image signals to the timing control unit 30.

The timing control unit 30 can be used to control the gate driving unit 80 to partially or totally disable the gate lines 82 according to the features of the image signals, and can be used to control the source driving unit 70, so that partial or total data lines will output high impedance signals.

The processor 50 is coupled to the timing control unit 30 and the frame buffer unit 40, for processing image signals and transmitting the processed image signals to the timing control unit 30 and the frame buffer unit 40. Besides, the processor can be also coupled to the register unit 76 and the enabling unit 85 for outputting control signals to the register unit 76 and the enabling unit 85 according to the locations of the static images, to control the register unit 76 and the enabling unit 85.

The operating system 60 is coupled to the processor 50, for transmitting image signals to the processor 50. The operating system 60 can be the windows system in a personal computer, or other operating systems, but is not limited to a specific system. Besides, the operating system 60 can be coupled to the register 76 and the enabling signal 85 for outputting control signals to the register unit 76 and the enabling unit 85 according to the locations of the static images, to control the register unit 76 and the enabling unit 85. The enabling unit 85 is used to disable a set of the gate lines 82 when the feature of the image signal corresponding to the set of gate lines belongs to remaining, slow or text. The aforementioned static images refer to an image that does not vary significantly, e.g. a wallpaper of windows, a web page having a lot of characters, a PowerPoint presentation, or a picture. Compared with the static image, the image of a movie, a PC game or a screen saver changes relatively significantly.

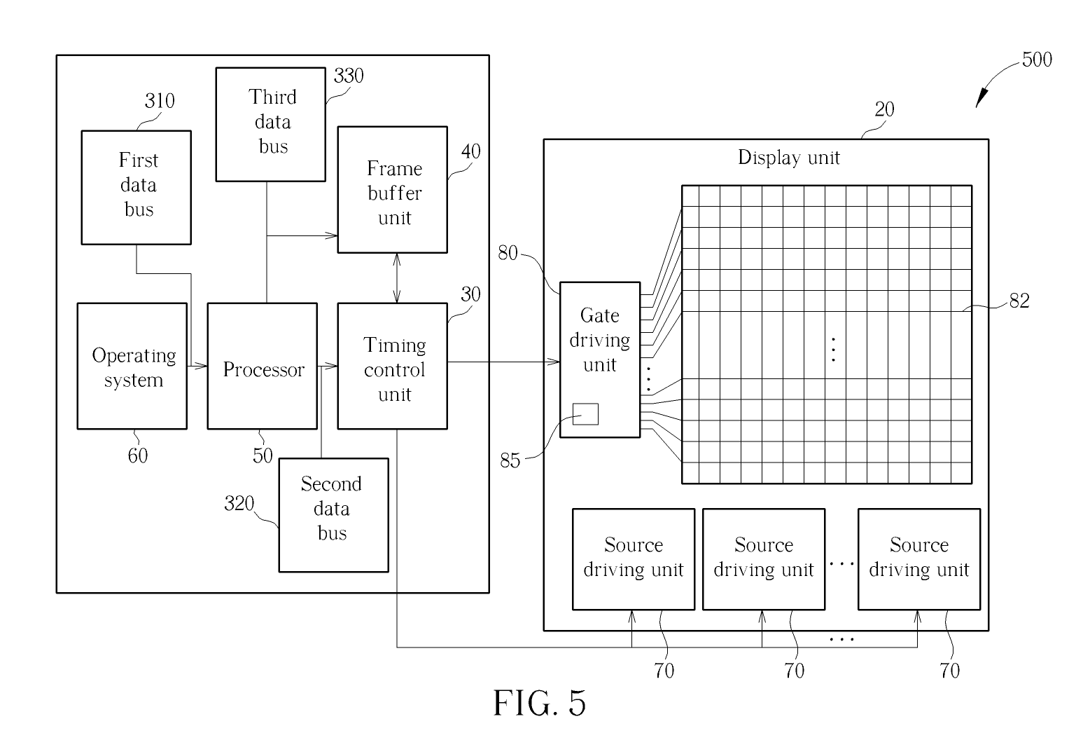

The display control system 100 can further comprise a determining unit for determining features of image signals and transmitting features of image signals to the processor and 50 the timing control unit 30, to make the processor 50 and the timing control unit 30 hold, update, modify or process image signals accordingly. The present invention does not limit the determining unit to be configured at a specific position in the display control system 100. The determining unit can be configured in the processor 50, the operating system 60 or the timing control system. The determining unit can be used to turn off at least one data bus of the first data bus 310, the second data bus 320 and the third data bus 330 (shown in FIG. 5), and to control one of the processor 50, the timing control unit 30 or the frame buffer unit 40 to enter a sleep, standby or pause status.

The processor 50, the timing control unit 30, the source driving unit 70 and the determining unit can optionally disable part or all functions of the display control system 100 according to features of image signals.

The timing control unit 30 can be configured to couple to the register unit 76 in the source driving unit 70 and the enabling unit 85 in the gate driving unit 80, so that the timing control unit 30 outputs control signals to the register unit 76 and the enabling unit 85. Besides, the processor 50 can be configured to couple to the register unit 76 in the source driving unit 70 and the enabling unit 85 in the gate driving unit 80, so that the processor 50 outputs control signals to the register unit 76 and the enabling unit 85.

Through the configuration of the first embodiment, controlling the switch 74 of the source driving unit 70 to output image signals or high impedance signals, and controlling the enabling or the disabling of the enabling unit 85 in the gate driving unit 80, the gate lines can be disabled when the image corresponding to the gate line 82 is a static image to reduce the power consumption of the display. Whether the image displayed by the display unit 20 is partially static or fully static, the power consumption of a display can be reduced by applying the display controlling system 100 to the display.

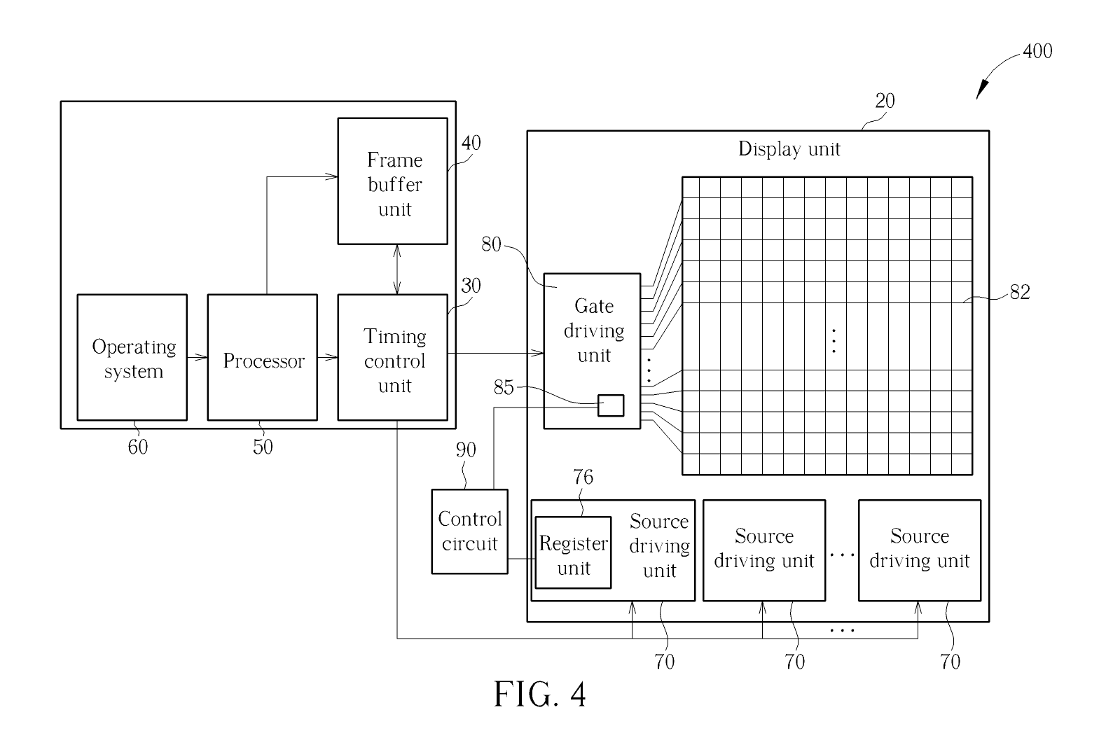

Please refer to FIG. 4, which shows a display control system 400 according a second embodiment of the present invention. The difference between the display control systems 100 and 400 is that, the display control system 400 further comprises a control circuit 90 coupled to the register unit 76 in the source driving unit 70 and at least an enabling unit 85 for outputting control signals to the register unit 76 and the enabling unit 85, to control the register unit 76 and the enabling unit 85.

Please refer to FIG. 5, which shows a display control system 500 according a third embodiment of the present invention. The difference between the display control systems 100 and 500 is that, the display control system 500 further comprises a first data bus 310, a second data bus 320 and a third data bus 330. The first data bus 310 is coupled to the operating system 60 and the processor 50. The second data bus 320 is coupled to the processor 50 and the timing control unit 30. The third data bus 330 is coupled to the processor 50 and the frame buffer unit 40. When the display unit 20 displays a fully static image, at least one of the first data bus 310, the second data bus 320 and the third data bus 330 will be turned off, to control one of the processor 50, the timing control unit 30 or the frame 40 buffer unit to enter a sleep, standby or pause status. Thus, the power consumption of a display can be further reduced by applying the display control system 500.

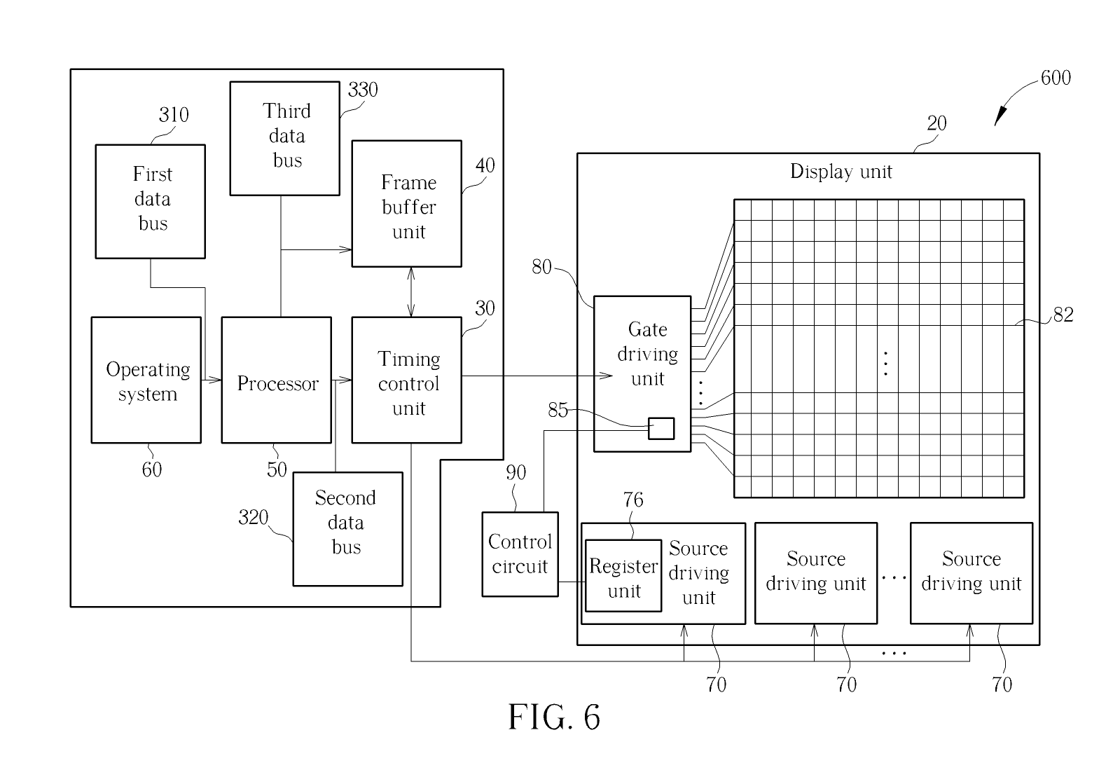

Please refer to FIG. 6, which shows a display control system 600 according a fourth embodiment of the present invention. The difference between the display control systems 400 and 600 is that, the display control system 600 further comprises a first data bus 310, a second data bus 320 and a third data bus 330. The first data bus 310 is coupled to the operating system 60 and the processor 50. The second data bus 320 is coupled to the processor 50 and the timing control unit 30. The third data bus 330 is coupled to the processor 50 and the frame buffer unit 40. When the display unit 20 displays features of image signals corresponding to an image, the determining unit can be used to determine the features of signals, and will turn off one of the first data bus 310, the second data bus 320 and the third data bus 330 and control one of the processor 50, the timing control unit 30 or the frame buffer unit 40 to enter a sleep, standby or pause status.

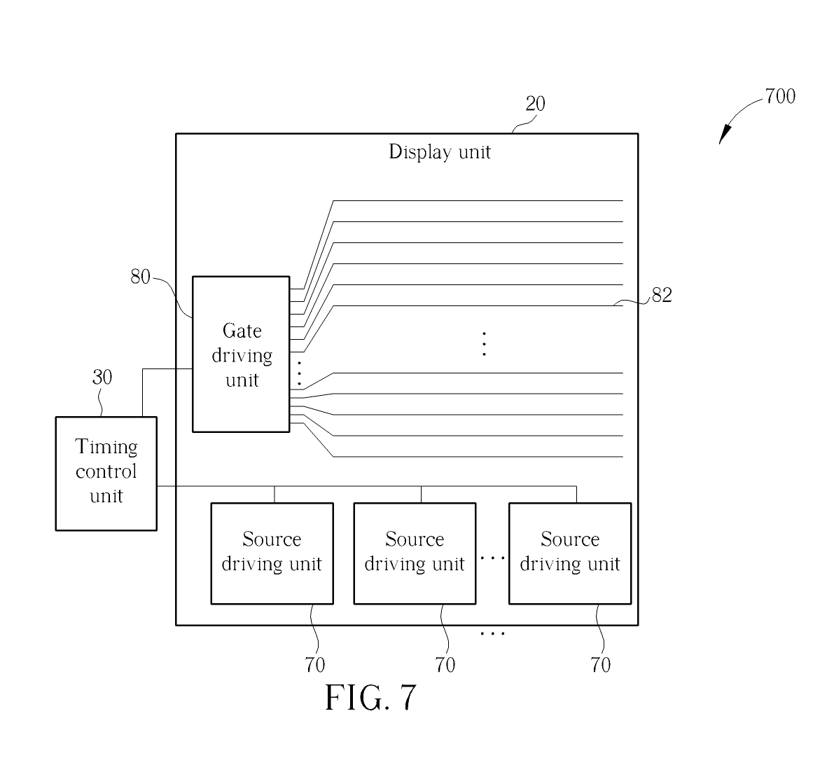

Please refer to FIG. 7, which shows an electronic device 700 according a fifth embodiment of the present invention. Similar to the first embodiment, the electronic device 700 comprises a plurality of source driving units 70, a timing control unit 30 and the gate driving units 80. Similarly, each source driving unit of the plurality of source driving units 70 has a position orientating serial number or a sequential number. With this configuration, the electronic device 700 can respectively control each source driving unit of the plurality of source driving units 70 quickly and effectively.

The timing control unit 30 is coupled to the plurality of source driving units 70 for controlling the plurality of source driving units 70 according to sequential numbers of the plurality of source driving units 70.

The gate driving unit 80 is coupled to a plurality of sets of gate lines 82. Each set of the plurality of sets of gate lines 82 comprises a plurality of gate lines. The gate driving unit 80 is used to respectively control each set of the plurality sets of gate lines 82 to be disabled or enabled. As previously described for the display control system 100, the electronic device 700 also can achieve the goal of reducing the power consumption, and can be applied in various display devices besides the display control system 100.

Through the configuration of the first to the fourth embodiments, the display control systems 100, 400, 500 and 600 can reduce the power consumption of the display when the display shows a static image, or an image that is partially static, thus solving the problem that the power consumption of the prior art display cannot be reduced when the prior art display is being used by a user, and solving the problem that the power consumption of the prior display cannot be reduced when the prior display is displaying a partially static image. Besides, the electronic device 700 can be applied in various display devices to achieve the goal of reducing the power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display control system comprising:
a display unit comprising:
at least one source driving unit comprising:
an output buffer unit for outputting image signals or high impedance signals;
a plurality of switches coupled to the output buffer unit, each switch of the plurality of switches comprising:
an input end coupled to the output buffer unit, for receiving the image signals transmitted from the output buffer unit; and
an output end coupled to at least one data line for outputting the image signals or high impedance signals transmitted from the output buffer unit to the input end to the at least one data line;
a register unit coupled to the control end of the switch for controlling the switch to output image signals or high impedance signals to the at least one data line, or for outputting an open circuit signal to the at least one data line; and
a gate driving unit coupled to the plurality of gate lines, for outputting gate driving signals to the plurality of gate lines; and
a timing control unit, coupled to the output buffer unit and the gate driving unit, for outputting image signals to the output buffer unit and controlling timings of the at least one source driving unit and the gate driving unit.

2. The display control system of claim 1, wherein the timing control unit controls the gate driving unit to disable part or all of the gate lines according to features of the image signals, and controlling the at least one source diving unit to control part or all of the data lines to output high impedance signals.

3. The display control system of claim 2, wherein the timing control unit is coupled to the register unit and the at least one enabling unit for outputting control signals to the register unit and the at lest one enabling unit according to features of the image signals, and a processor is coupled the register unit and the at least one enabling unit for outputting control signals to the register unit and the at lest one enabling unit according to features of the image signals.

4. The display control system of claim 1, wherein all of the data lines are grouped into a plurality of sets of data lines, and the at least one source driving unit is used to respectively control each set of the plurality of sets of data lines to output image signals or high impedance signals.

5. The display control system of claim 1, wherein the plurality of gate lines are grouped into a plurality of sets of gate lines, and the gate driving unit is used to respectively control timing of each set of the plurality sets of gate lines.

6. The display control system of claim 1, wherein the plurality of gate lines are grouped into a plurality of sets of gate lines and the gate driving unit is used to respectively control each set of the plurality sets of gate lines to be disabled or enabled.

7. The display control system of claim 1, further comprising:
a processor coupled to the timing control unit for processing image signals and transmitting processed image signals to the timing control unit; and
a determining unit for determining features of image signals and transmitting features of image signals to the processor and the timing control unit, to make the processor and the timing control unit hold, update, modify or process image signals accordingly.

8. The display control system of claim 7, wherein the determining unit is configured in the processor, an operation system or the timing control unit.

9. The display control system of claim 1, further comprising:
an operation system coupled to the processor for transmitting image signals to the processor and the timing control unit. and
a determining unit for determining features of image signals and transmitting features of image signals to the processor and the timing control unit, to make the processor and the timing control unit hold, update, modify or process image signals accordingly.

10. The display control system of claim 9, wherein the determining unit is configured in the processor, an operation system or the timing control unit.

11. The display control system of claim 1, wherein the gate driving unit comprises at least one enabling unit, each enabling unit of the at least one enabling unit is used to disable a set of gate lines when features of image signals corresponding to the set of gate lines belong to a static image, a slow image or a text image.

12. The display control system of claim 1, wherein the timing control unit is coupled to the register unit and the at least one enabling unit for outputting control signals to the register unit and the at least one enabling unit according to features of the image signals and a processor is coupled to the register unit and the at least one enabling unit for outputting control signals to the register unit and the at least one enabling unit according to the features of the image signals.

13. The display control system of claim 1, further comprising a control circuit coupled to the register unit and the at least one enabling unit for outputting control signals to the register unit and the at least one enabling unit according to positions of a static image.

14. The display control system of claim 1, wherein a processor, the timing control unit, a determining unit and the at least one source driving unit can optionally disable part or all functions of the display control system according to features of image signals.

15. The display control system of claim 1, wherein the gate driving unit comprises an enabling unit coupled to the gate lines, for disabling the gate lines when features of image signals corresponding to the gate lines belong to a static image, a slow image or a text image.

16. The display control system of claim 1, further comprising:
a first data bus coupled to an operation system and a processor;
a second data bus coupled to the timing control unit and the processor; and
a third data bus coupled to a frame buffer unit and the processor;
wherein a determining unit turns off one of the first data bus, the second data bus and the third data bus and controls one of the processor, the timing control unit and the frame buffer unit to enter a sleep, standby or pause status.

17. An electronic device, comprising:
a plurality of source driving units, each source driving unit of the plurality of source driving units having a position orientating serial number or a sequential number; and
a timing control unit coupled to the plurality of source driving units for controlling the plurality of source driving units according to sequential numbers of the plurality of source driving units.

18. The electronic device of claim 17, wherein each source driving unit of the plurality of source driving units comprises:
an output buffer unit for outputting image signals;
a plurality of switches coupled to the output buffer unit, each switch of the plurality of switches comprising:
an input end, coupled to the output buffer unit, for receiving the image signals transmitted from the output buffer unit; and
an output end coupled to at least one data line, for outputting the image signals or high impedance signals transmitted from the output buffer unit to the input end to the at least one data line; and
a register unit coupled to the control end of the switch for controlling the switch to output image signals or high impedance signals to the at least one data line.

19. The electronic device of claim 18, further comprising a gate driving unit coupled to a plurality of sets of gate lines, each set of the plurality of sets of gate lines comprises a plurality of gate lines, the gate driving unit is used to respectively control each set of the plurality sets of gate lines to be disabled or enabled.

20. The electronic device of claim 17, further comprising a gate driving unit coupled to a plurality of sets of gate lines, each set of the plurality sets of gate lines comprises a plurality of gate lines, a gate driving unit is used to respectively control each set of the plurality sets of gate lines to be disabled or enabled.
